(19) United States
(12) Patent Application Publication
(10) Pub. No.: US 2025/0147744 A1
(43) Pub. Date: May 8, 2025

(54) Compiler Back-End Reuse Method, Apparatus, Compiler, and Storage Medium

(71) Applicants: Verisilicon Microelectronics (Chengdu) Co., Ltd., Sichuan (CN); VeriSilicon Microelectronics (Shanghai) Co., Ltd., Shanghai (CN); Verisilicon Technology (Shanghai) Co., Ltd., Shanghai (CN); Verisilicon Microelectronics (Hainan) Co., Ltd., Hainan (CN); Verisilicon Microelectronics (Nanjing) Co., Ltd., Jiangsu (CN)

(72) Inventor: Tingting Yu, Sichuan (CN)

(21) Appl. No.: 18/823,264

(22) Filed: Sep. 3, 2024

(30) Foreign Application Priority Data
Nov. 8, 2023 (CN) 2023114898870

(51) Int. Cl. G06F 8/41

(52) U.S. Cl. CPC G06F 8/447

(57) ABSTRACT

Provided are to a compiler back-end reuse method, apparatus, compiler, and computer-readable storage medium. The compiler back-end reuse method includes: acquiring a shader code and being compiled by a compiler front-end to obtain an intermediate code; converting the intermediate code into a target intermediate code of a preset format; converting an original resource identifier corresponding to the intermediate code into a target resource identifier of the preset format; and sending the target intermediate code and the target resource identifier to the compiler back-end to generate a target machine code.

### CROSS-REFERENCE TO RELATED APPLICATION

The present disclosure claims the priority to the Chinese patent application with the filing No. 2023114898870 filed with the Chinese Patent Office on Nov. 8, 2023, and entitled “COMPILER BACK-END REUSE METHOD, APPARATUS, COMPILER, AND STORAGE MEDIUM”, the contents of which are incorporated herein by reference in entirety.

### TECHNICAL FIELD

The present disclosure relates to the field of image processing, and specifically relates to a compiler back-end reuse method, apparatus, compiler, and computer-readable storage medium.

### BACKGROUND ART

A shader language is a development language for a programmable GPU (graphics processing unit) pipeline, and codes written in the shader language will be compiled by a shader compiler into machine code that can be executed by the GPU. The common shader languages at present are HLSL (High Level Shader Language) for Directx, GLSL (Opengl Shading Language) for Opengl, etc. These shader languages are not syntactically compatible with each other and have their own compilers for each platform.

The Directx uses HLSL as the shader programming language. After passing through the compiler front-end, the HLSL is compiled into the intermediate code DXIL (Directx Intermediate Language), and the GLSL proposes SPIR-V (Standard Portable Intermediate Representation) as the intermediate code. Both the DXIL and the SPIR-V can be configured to realize the shader compiler for the graphic and the parallel computing field. The compiler of GPU or GPGPU often needs to support these two types of intermediate codes, so as to compatibly support applications developed with different software stacks.

When GPU vendors support multiple industry standards, multiple compilers need to be developed for intermediate code output by different front-ends. The compiler front-end is usually finished by third-party tools since it is hardware-independent. The compiler back-end (including optimizers and/or linkers) must be developed by each GPU vendor due to the complexity of the GPU hardware, which is often very large and complex. If the complex back-end cannot be reused, the amount of engineering required to support a new intermediate code will extend the development cycle by several times.

### SUMMARY

The object of the present disclosure is to provide a compiler back-end reuse method, apparatus, compiler, and computer-readable storage medium, which can realize the compiler back-end reuse for different shader languages.

In a first aspect, the embodiments of the present disclosure provide a compiler back-end reuse method, including: acquiring an intermediate code obtained by compiling a shader code by a compiler front-end; converting the intermediate code into a target intermediate code of a preset format; converting an original resource identifier corresponding to the intermediate code into a target resource identifier of the preset format; and sending the target intermediate code and the target resource identifier to the compiler back-end to generate a target machine code.

Compared with the prior art, the embodiments of the present disclosure provide the compiler back-end reuse method. For shader code of any format, after the intermediate code is compiled by the compiler front-end, the intermediate code is converted into the target intermediate code of the preset format, and the original resource identifier corresponding to the intermediate code is converted into the target resource identifier of the preset format. The target intermediate code and target resource identifier are the formats that can be supported and used by the compiler back-end, and then the compiler back-end can use the target intermediate code and the target resource identifier to generate the target machine code, so that the compiler back-end can reuse the shader code of any format and the corresponding intermediate code, which realizes the reuse of the compiler back-end for different shader languages.

In an optional embodiment, the step of converting the original resource identifier corresponding to the intermediate code into the target resource identifier of the preset format includes: determining an original resource type identifier and an original binding number in the original resource identifier; converting the original resource type identifier into a target resource type identifier of the preset format; and converting the original binding number into a target binding number of the preset format.

In an optional embodiment, the step of converting the original resource type identifier into the target resource type identifier of the preset format includes: acquiring a preset corresponding relationship, wherein the preset corresponding relationship comprises a corresponding relationship between the resource type identifier of the preset format and resource type identifiers of other formats; and converting the original resource type identifier into the target resource type identifier according to the preset corresponding relationship. Converting the original resource type identifier to the target resource type identifier by the preset corresponding relationship can reduce the amount of computation and improve the conversion efficiency.

In an optional embodiment, a format of the original resource type identifier is SPIR-V format, and a format of the target resource type identifier is DXIL format.

In an optional embodiment, the step of converting the original binding number into the target binding number of the preset format includes: forming the target binding number after sequentially numbering the same original binding numbers corresponding to different resources.

In an optional embodiment, the compiler back-end reuse method further includes: acquiring a useless resource that is not used by the target intermediate code; acquiring a useless set number of the useless resource, and mapping the useless set number to a preset set number; acquiring the useless resource according to the useless set number in the preset set number, and deleting the useless resource. Uniformly deleting the useless resource according to the preset set number can improve the efficiency of deleting the useless resource, and additionally, deleting the useless resource can reduce resource redundancy and improve the efficiency of generating the target machine code.

In an optional embodiment, the compiler back-end reuse method further includes: acquiring a read instruction of reading the useless resource according to the useless set number in the preset set number, and deleting the read instruction; or acquiring a write instruction of writing the useless resource according to the useless set number in the preset set number, and deleting the write instruction; or acquiring the read instruction of reading the useless resource and the write instruction of writing the useless resource according to the useless set number in the preset set number, and deleting the read instruction and the write instruction. Deleting the read instruction and/or the write instruction can reduce the instruction redundancy in the target intermediate code, and further improve the efficiency of generating the target machine code.

In a second aspect, the embodiments of the present disclosure provide a compiler back-end reuse apparatus, including: a communication module, wherein the communication module is configured to acquire an intermediate code obtained by compiling a shader code by a compiler front-end; an intermediate code conversion module, wherein the intermediate code conversion module is configured to convert the intermediate code into the target intermediate code of the preset format; and a resource identifier conversion module, wherein the resource identifier conversion module is configured to convert the original resource identifier corresponding to the intermediate code into the target resource identifier of the preset format, wherein the communication module is further configured to send the target intermediate code and the target resource identifier to the compiler back-end, so as to send the target intermediate code and the target resource identifier to the compiler back-end to generate the target machine code.

In an optional embodiment, the step of converting an original resource identifier corresponding to the intermediate code into a target resource identifier of the preset format comprises: determining an original resource type identifier and an original binding number in the original resource identifier; converting the original resource type identifier into a target resource type identifier of the preset format; and converting the original binding number into a target binding number of the preset format.

In an optional embodiment, the step of converting the original resource type identifier into a target resource type identifier of the preset format comprises: acquiring a preset corresponding relationship, wherein the preset corresponding relationship comprises a corresponding relationship between a resource type identifier of the preset format and resource type identifiers of other formats; and converting the original resource type identifier into the target resource type identifier according to the preset corresponding relationship.

In an optional embodiment, a format of the original resource type identifier is SPIR-V format, and a format of the target resource type identifier is DXIL format.

In an optional embodiment, the step of converting the original binding number into a target binding number of the preset format comprises: forming the target binding number after sequentially numbering the same original binding numbers corresponding to different resources.

In an optional embodiment, the compiler back-end reuse method further comprises: acquiring a useless resource that is not used by the target intermediate code; acquiring a useless set number of the useless resource, and mapping the useless set number to a preset set number; and acquiring the useless resource according to the useless set number in the preset set number, and deleting the useless resource.

In an optional embodiment, the compiler back-end reuse method further comprises: acquiring a read instruction of reading the useless resource according to the useless set number in the preset set number, and deleting the read instruction; or acquiring a write instruction of writing the useless resource according to the useless set number in the preset set number, and deleting the write instruction; or acquiring the read instruction of reading the useless resource and the write instruction of writing the useless resource according to the useless set number in the preset set number, and deleting the read instruction and the write instruction.

Compared with the prior art, the embodiments of the present disclosure provide the compiler back-end reuse apparatus. For shader code of any format, after the intermediate code is compiled by the compiler front-end, the communication module can acquire the intermediate code from the compiler front-end, the intermediate code conversion module converts the intermediate code into the target intermediate code of the preset format, and the resource identifier conversion module converts the original resource identifier corresponding to the intermediate code into the target resource identifier of the preset format, wherein the target intermediate code and target resource identifier are the formats that can be supported and used by the compiler back-end. After the target intermediate code and target resource identifier are obtained by conversion, the communication module sends the target intermediate code and target resource identifier to the compiler back-end, and then the compiler back-end can use the target intermediate code and the target resource identifier to generate the target machine code, so that the compiler back-end can reuse the shader code of any format and the corresponding intermediate code, which realizes the reuse of the compiler back-end for different shader languages.

In a third aspect, the embodiments of the present disclosure provide a compiler, including: the compiler front-end, wherein the compiler front-end is configured to compile the shader code to obtain the intermediate code; the compiler back-end reuse apparatus as described above, wherein the compiler back-end reuse apparatus is configured to generate the target intermediate code and the target resource identifier of the preset format according to the intermediate code; and the compiler back-end, wherein the compiler back-end is configured to generate the target machine code according to the target intermediate code and the target resource identifier.

Compared with the prior art, the compiler provided by the embodiments of the present disclosure includes the compiler back-end reuse apparatus as described above. The compiler back-end reuse apparatus can generate the target intermediate code and target resource identifier of the preset format according to the intermediate code, and then the compiler back-end can generate the target machine code according to the target intermediate code and target resource identifier. Regardless of the format of the shader code input to the compiler, the target intermediate code and target resource identifier used by the compiler back-end to generate the target machine code are always the preset format converted by the compiler back-end reuse apparatus, which realizes the reuses of the compiler back-end for different shader languages.

In a fourth aspect, the embodiments of the present disclosure provide a computer-readable storage medium storing a computer program, wherein the computer program is executed by a processor to realize the foregoing compiler back-end reuse method.

Compared with the prior art, the embodiments of the present disclosure provide the compiler back-end reuse method, apparatus, compiler, and computer-readable storage medium. The intermediate code is converted into the target intermediate code of the preset format by converting the format of the intermediate code compiled from the shader codes of different formats, and the original resource identifier corresponding to the intermediate code is converted into the target resource identifier of the preset format, wherein the target intermediate code and the target resource identifier are the formats that can be supported and used by the compiler back-end, so that the compiler back-end can reuse the shader code of any format and the corresponding intermediate code, which realizes the reuse of the compiler back-end for different shader languages.

### BRIEF DESCRIPTION OF DRAWINGS

In order to more clearly illustrate the technical solutions of the embodiments of the present disclosure, the drawings to be used in the embodiments will be briefly introduced below. It should be understood that the following drawings show only certain embodiments of the present disclosure, and therefore should not be regarded as a limitation of the scope. For persons of ordinary skill in the art, other relevant drawings can be obtained by these drawings without inventive efforts.

FIG. 1 shows a schematic flow diagram of a compiler back-end reuse method provided by an embodiment of the present disclosure;

FIG. 2 shows a schematic structure diagram of a compiler back-end reuse apparatus provided by another embodiment of the present disclosure; and

FIG. 3 shows a schematic structure diagram of a compiler provided by another embodiment of the present disclosure.

### DETAILED DESCRIPTION OF EMBODIMENTS

In order to make the objects, technical solutions, and advantages of the embodiments of the present disclosure clearer, the technical solutions in the embodiments of the present disclosure will be described clearly and completely as follows in connection with the drawings in the embodiments of the present disclosure. It is obvious that the described embodiments are partial embodiments of the present disclosure and are not all the embodiments. The components of embodiments of the present disclosure generally described and shown in the drawings herein may be arranged and designed in various configurations.

Therefore, the following detailed description of embodiments of the present disclosure provided in the drawings is not intended to limit the scope of the present disclosure for which the protection is claimed, but rather represents only the embodiments selected by the present disclosure.

It should be noted that similar labels and letters indicate similar items in the following drawings, so that once an item is defined in a drawing, it does not need to be further defined and explained in subsequent drawings.

Additionally, the terms “first”, “second”, etc., are only used to distinguish the description and cannot be understood as indicating or implying relative importance.

It is noted that features in embodiments of the present disclosure can be combined with each other without conflict.

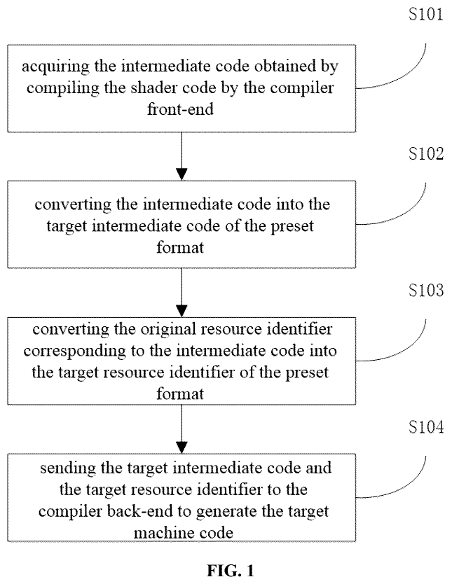

An embodiment of the present disclosure provides a compiler back-end reuse method applied to a compiler back-end reuse apparatus, as shown in FIG. 1, including the following steps.

Step S101: acquiring an intermediate code obtained by compiling a shader code by a compiler front-end.

Specifically, the corresponding intermediate code is obtained after the shader codes of different formats are compiled by the corresponding compiler front-end. After the compiler front-end compiles to obtain the corresponding intermediate code, the intermediate code is sent to the compiler back-end reuse apparatus, wherein the compiler back-end reuse apparatus acquires the intermediate code from the compiler front-end by receiving signals.

Step S102: converting the intermediate code into the target intermediate code of the preset format.

In this step, the target intermediate code of a uniform preset format can be used, i.e., the intermediate codes of any formats are converted into the target intermediate codes of a uniform preset format. In some embodiments of the present disclosure, the target intermediate code can be used for the target GPU, can completely and clearly express the shader program at each stage and can be easily mapped to the machine code on the GPU.

In some embodiments of the present disclosure, for example, the DXIL format can be configured as the preset format to convert the intermediate codes of other formats such as SPIR-V into the target intermediate code of the DXIL format, wherein it can be arranged based on the format of the intermediate code supported by the compiler back-end according to the reuse of actual needs.

Step S103: converting the original resource identifier corresponding to the intermediate code into the target resource identifier of the preset format.

Specifically, when the compiler back-end generates the machine code, it needs to know the resource required by the GPU program corresponding to the shader code and the location layout of the resource, so as to allocate the physical addresses corresponding to the resource. The intermediate codes of different formats have different identification methods for resource layouts. In this step, the original resource identifiers corresponding to the intermediate codes of different formats are converted to the target resource identifier of the preset format.

In some embodiments of the present disclosure, the original resource identifier corresponding to the intermediate code and the target resource identifier of the preset format can both use a resource corresponding to the resource type identifier and the binding number identifier. When converting the original resource identifier corresponding to the intermediate code into the target resource identifier of the preset format, it can first determine the original resource type identifier and the original binding number in the original resource identifier; and then correspondingly convert the original resource type identifier into the target resource type identifier of the preset format, and convert the original binding number into the target binding number of the preset format.

For example, the original resource type identifier can be converted into the target resource type identifier of the preset format according to the preset corresponding relationship, wherein the preset corresponding relationship includes a corresponding relationship between the resource type identifier of the preset format and the resource type identifier of another format. Taking the preset format as DXIL format as an example, in the intermediate code of the DXIL format, as shown in Table 1 below, resources are divided into the following 9 types, wherein each type of resource corresponds to a different resource type identifier.

TABLE 1

| Resource type | Resource type identifier |
|---|---|
| Sampler | Sampler Or Combined_Image_Sampler |
| Sampled image | Sampled_Image Or Combined_Image_Sampler |
| Storage image | Storage_Image |
| Combined image sampler | Combined_Image_Sampler |
| Uniform texel buffer | Uniform_Texel_Buffer |
| Storage texel buffer | Storage_Texel_Buffer |
| Uniform buffer | Uniform_Buffer Or Uniform_Buffer_Dynamic |
| Storage buffer | Storage_Buffer Or Storage_Buffer_Dynamic |
| Input attachment | Input_Attachment |

Taking the intermediate code as SPIR-V format as an example, the resource in the intermediate code of the SPIR-V format is divided into 4 types: t—for shader resource views (SRV), s—for sampler (sampler), u—for unordered access views (UAV), and b—for constant buffer views (CBV).

The preset corresponding relationships can be shown in Table 2 below, including:

TABLE 2

| DXIL format | Resource type identifier | Resource type identifier |
|---|---|---|
| resource type identifier | of preset format | of SPIR-V format |
| Sampler | Sampler | Sampler |
| Combined_Image_Sampler | Combined_Image_Sampler | |
| Sampled_Image | Sampled_Image | SRV (Texture) |
| Storage_Image | Storage_Image | |
| Uniform_Texel_Buffer | Uniform_Texel_Buffer | |
| Storage_Texel_Buffer | storage_texel_buffer | |
| Uniform_Buffer | uniform_buffer | CBV |
| Storage_Buffer | storage_buffer | SRV (Buffer) or UAV |
| Uniform_Buffer_Dynamic | uniform_buffer_dynamic | |
| Storage_Buffer_Dynamic | storage_buffer_dynamic | |
| Input_Attachment | input_attachment | |

In the preset corresponding relationship, when the preset format is DXIL format and the intermediate code is SPIR-V format, the original resource type identifier corresponding to the intermediate code includes sampler identifier, SRV_Texture identifier, SRV_Buffer identifier, UAV identifier, and CBV identifier. As shown in the above table, Sampler is still mapped as Sampler, and corresponds to the sampler in GPU; CBV is a constant buffer and is mapped as Uniform_Buffer in the DXIL format, i.e., an invariant buffer in GPU; SRV is divided into two types according to its subtypes, if it is Texture_texture type, it is mapped as Sampled_Image in the DXIL format, and corresponds to the texture buffer in GPU, and if it is Buffer_buffer type, it is mapped as Storage_Buffer in the DXIL format, and corresponds to display memory in GPU; and UAV is a read-write data buffer, and the GPU display memory can read and write, so UAV can also be mapped as Storage_Buffer in the DXIL format.

The step of converting the original resource type identifier into the target resource type identifier of the DXIL format according to the preset corresponding relationship includes: converting the sampler identifier into the sampler identifier (i.e., no conversion), converting the SRV_Texture identifier into the Sampled_Image identifier, converting the SRV_Buffer identifier into the Storage_Buffer identifier, converting the UAV identifier into the Storage_Buffer identifier, and converting the CBV identifier into the Uniform_Buffer identifier.

It is to be understood that the above is only an example of the preset corresponding relationship and conversion process when the preset format is the DXIL format and the intermediate code is the SPIR-V format in some embodiments of the present disclosure, and does not constitute a limitation.

Furthermore, in some other embodiments of the present disclosure, the step of converting the original binding number into the target binding number of the preset format can be: forming the target binding number after sequentially numbering the same original binding numbers corresponding to different resources.

Similarly, taking the preset format as the DXIL format and the intermediate code as SPIR-V format as an example, in the target intermediate code of the DXIL format, the resources with the same binding number correspond to the same resource location; and in the intermediate code of the SPIR-V format, the binding number is the same but the resource types are different, so as to correspond to different resource locations. Therefore, during the process of converting the original binding number of the SPIR-V format into the target binding number of the DXIL format, it is necessary to change the binding number when converted into the target intermediate code of the DXIL format for multiple different resources with the same original binding number and different resource types in the SPIR-V format, so as to avoid labeling the multiple different resources with the same binding number as the same resource in the target intermediate code of the DXIL format. Specifically, during the actual application process, it can form the target binding number by sequentially numbering the same original binding numbers corresponding to different resources. For example, the target binding numbers of the DXIL format converted by three different sources corresponding to the same binding number binding0 in the intermediate code of the SPIR-V format are binding0, binding1, and binding2, wherein the details are as follows:
before conversion:

set 0, binding 0, type = MY_SHADER_RESOURCE_TYPE_SAMPLED_IMAGE;
set 0, binding 0, type = MY_SHADER_RESOURCE_TYPE_UNIFORM_BUFFER;
set 0, binding 0, type = MY_SHADER_RESOURCE_TYPE_SAMPLER;

after conversion:

set 0, binding 0, type = MY_SHADER_RESOURCE_TYPE_SAMPLED_IMAGE;
set 0, binding 1, type = MY_SHADER_RESOURCE_TYPE_UNIFORM_BUFFER;
set 0, binding 2, type = MY_SHADER_RESOURCE_TYPE_SAMPLER.

Additionally, in some embodiments of the present disclosure, it can further include: acquiring the useless resource that is not used by the target intermediate code; acquiring the useless set number of the useless resource, and mapping the useless set number to the preset set number; acquiring the useless resource according to the useless set number in the preset set number, and deleting the useless resource.

During the process of converting the original resource identifier corresponding to the intermediate code into the target resource identifier of the preset format, partial resources may not be used by the shader program, i.e., these resources will not be used by the target intermediate code in the subsequent machine code generation. This part of unused resources are useless resources in the embodiments of the present disclosure. This part of useless resources can be deleted in the embodiments of the present disclosure. Specifically, during the process of converting the original resource identifier, after traversing all resources and discovering that a resource will not be used subsequently and belongs to the useless resource, the set number of the useless resource is mapped to the preset set number as the useless set number. Subsequently, the useless resource can be deleted uniformly by the useless set number, i.e., the useless resource is acquired according to each useless set number in the preset set number, and the useless resource is deleted. Uniformly deleting the useless resource according to the preset set number can improve the efficiency of deleting the useless resource, and additionally, deleting the useless resource can reduce resource redundancy and improve the efficiency of generating the target machine code.

Furthermore, in some other embodiments of the present disclosure, when uniformly deleting the useless resource according to the preset set number, it can further acquire the read instruction of reading the useless resource according to the useless set number in the preset set number, and delete the read instruction; or acquire the write instruction of writing the useless resource according to the useless set number in the preset set number, and delete the write instruction; or acquire the read instruction of reading the useless resource and the write instruction of writing the useless resource according to the useless set number in the preset set number, and delete the read instruction and the write instruction The step of acquiring the read instruction of reading the useless resource and/or the write instruction of reading the useless resource and deleting them can reduce the instruction redundancy in the target intermediate code, and further improve the efficiency of generating the target machine code.

Step S104: sending the target intermediate code and the target resource identifier to the compiler back-end to generate the target machine code.

Specifically, after completing the conversion of the intermediate code and the original resource identifier to the target intermediate code and the target resource identifier of the preset format, the compiler back-end reuse apparatus can send the target intermediate code and the target resource identifier to the compiler back-end. The compiler back-end generates the target machine code according to the target intermediate code and the target resource identifier, so as to complete the complete compilation process for the shader code.

In the compiler back-end reuse method provided by the embodiment of the present disclosure, for shader code of any format, after the intermediate code is compiled by the compiler front-end, the intermediate code is converted into the target intermediate code of the preset format, and the original resource identifier corresponding to the intermediate code is converted into the target resource identifier of the preset format. The target intermediate code and target resource identifier are the formats that can be supported and used by the compiler back-end, and then the compiler back-end can use the target intermediate code and target resource identifier to generate the target machine code, so that the compiler back-end can reuse the shader code of any format and the corresponding intermediate code, which realizes the reuse of the compiler back-end for different shader languages.

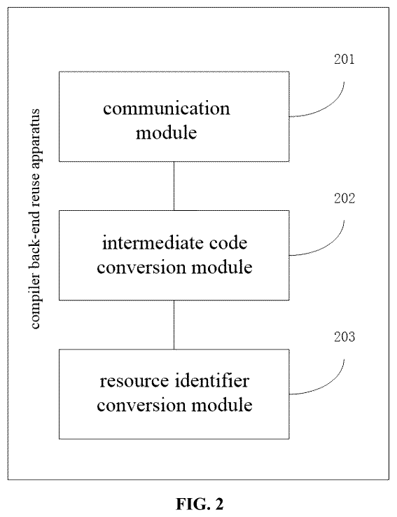

The another embodiment of the present disclosure relates to a compiler back-end reuse apparatus, as shown in FIG. 2, including: a communication module 201, wherein the communication module 201 is configured to acquire the intermediate code obtained by compiling the shader code by the compiler front-end; an intermediate code conversion module 202, wherein the intermediate code conversion module 202 is configured to convert the intermediate code into the target intermediate code of the preset format; and a resource identifier conversion module 203, wherein the resource identifier conversion module 203 is configured to convert the original resource identifier corresponding to the intermediate code into the target resource identifier of the preset format, wherein the communication module 201 is further configured to send the target intermediate code and the target resource identifier to the compiler back-end, so as to send the target intermediate code and the target resource identifier to the compiler back-end to generate the target machine code.

In the compiler back-end reuse apparatus provided by another embodiment of the present disclosure, for shader code of any format, after the intermediate code is compiled by the compiler front-end, the communication module 201 can acquire the intermediate code from the compiler front-end, the intermediate code conversion module 202 converts the intermediate code into the target intermediate code of the preset format, and the resource identifier conversion module 203 converts the original resource identifier corresponding to the intermediate code into the target resource identifier of the preset format, wherein the target intermediate code and target resource identifier are the formats that can be supported and used by the compiler back-end. After the target intermediate code and target resource identifier are obtained by conversion, the communication module 201 sends the target intermediate code and the target resource identifier to the compiler back-end, and then the compiler back-end can use the target intermediate code and the target resource identifier to generate the target machine code, so that the compiler back-end can reuse the shader code of any format and the corresponding intermediate code, which realizes the reuse of the compiler back-end for different shader languages.

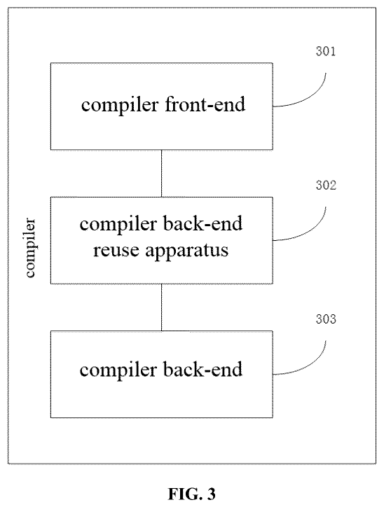

The another embodiment of the present disclosure relates to a compiler, as shown in FIG. 3, including: a compiler front-end 301, wherein the compiler front-end 301 is configured to compile the shader code to obtain the intermediate code; a compiler back-end reuse apparatus 302 described in the forgoing embodiments, wherein the compiler back-end reuse apparatus 302 is configured to generate the target intermediate code and the target resource identifier of the preset format; and a compiler back-end 303, wherein the compiler back-end 303 is configured to generate the target machine code according to the target intermediate code and the target resource identifier.

The compiler provided by another embodiment of the present disclosure includes the compiler back-end reuse apparatus 302 as described in the foregoing embodiments. The compiler back-end reuse apparatus 302 can generate the target intermediate code and target resource identifier of the preset format according to the intermediate code, i.e., the compiler back-end 303 can generate the target machine code according to the target intermediate code and target resource identifier. Regardless of the format of the shader code input to the compiler, the target intermediate code and target resource identifier used by the compiler back-end 303 to generate the target machine code are always the preset formats converted by the compiler back-end reuse apparatus 302, which realizes the reuses of the compiler back-end for different shader languages.

The another embodiment of the present disclosure relates to a computer-readable storage medium storing a computer program. The above method embodiments are realized when the computer program is executed by the processor.

That is to say, the person skilled in the art can understand that all or part of the steps to realize the above method embodiments can be completed by instructing relevant hardware by the program. The program is stored in a storage medium and includes several instructions, so that a device (which can be a microcontroller, chip, etc.) or processor executes all or part of steps of the method in each embodiment of the present disclosure. The foregoing storage medium includes a USB flash drive, portable hard disk, ROM (Read-Only Memory), RAM (Random Access Memory), magnetic disk, or optical disk, and other medium that can store program code.

The above is only specific embodiments of the present disclosure, but the scope of protection of the present disclosure is not limited thereto. Any changes or substitutions that can be easily thought of by any person skilled familiar with the technical field within the technical scope disclosed by the present disclosure, shall be covered in the scope of protection of the present disclosure. Therefore, the scope of protection of the present disclosure shall be governed by the scope of protection of the claims.

What is claimed is:

1. A compiler back-end reuse method, comprising:
acquiring an intermediate code obtained by compiling a shader code by a compiler front-end;
converting the intermediate code into a target intermediate code of a preset format;
converting an original resource identifier corresponding to the intermediate code into a target resource identifier of the preset format; and
sending the target intermediate code and the target resource identifier to the compiler back-end to generate a target machine code.

2. The compiler back-end reuse method according to claim 1, wherein the step of converting an original resource identifier corresponding to the intermediate code into a target resource identifier of the preset format comprises:
determining an original resource type identifier and an original binding number in the original resource identifier;
converting the original resource type identifier into a target resource type identifier of the preset format; and
converting the original binding number into a target binding number of the preset format.

3. The compiler back-end reuse method according to claim 2, wherein the step of converting the original resource type identifier into a target resource type identifier of the preset format comprises:
acquiring a preset corresponding relationship, wherein the preset corresponding relationship comprises a corresponding relationship between a resource type identifier of the preset format and resource type identifiers of other formats; and
converting the original resource type identifier into the target resource type identifier according to the preset corresponding relationship.

4. The compiler back-end reuse method according to claim 2, wherein a format of the original resource type identifier is SPIR-V format, and a format of the target resource type identifier is DXIL format.

5. The compiler back-end reuse method according to claim 2, wherein the step of converting the original binding number into a target binding number of the preset format comprises:
forming the target binding number after sequentially numbering the same original binding numbers corresponding to different resources.

6. The compiler back-end reuse method according to claim 1, wherein the compiler back-end reuse method further comprises:
acquiring a useless resource that is not used by the target intermediate code;
acquiring a useless set number of the useless resource, and mapping the useless set number to a preset set number; and
acquiring the useless resource according to the useless set number in the preset set number, and deleting the useless resource.

7. The compiler back-end reuse method according to claim 6, wherein the compiler back-end reuse method further comprises:
acquiring a read instruction of reading the useless resource according to the useless set number in the preset set number, and deleting the read instruction; or
acquiring a write instruction of writing the useless resource according to the useless set number in the preset set number, and deleting the write instruction; or
acquiring the read instruction of reading the useless resource and the write instruction of writing the useless resource according to the useless set number in the preset set number, and deleting the read instruction and the write instruction.

8. A compiler back-end reuse apparatus, comprising:
a communication module, wherein the communication module is configured to acquire an intermediate code obtained by compiling a shader code by a compiler front-end;
an intermediate code conversion module, wherein the intermediate code conversion module is configured to convert the intermediate code into a target intermediate code of a preset format; and
a resource identifier conversion module, wherein the resource identifier conversion module is configured to convert an original resource identifier corresponding to the intermediate code into a target resource identifier of the preset format, wherein
the communication module is further configured to send the target intermediate code and the target resource identifier to the compiler back-end, so as to send the target intermediate code and the target resource identifier to the compiler back-end to generate a target machine code.

9. A compiler including the compiler back-end reuse apparatus of claim 8, the compiler comprising:
a compiler front-end, wherein the compiler front-end is configured to compile the shader code to obtain the intermediate code;
the compiler back-end reuse apparatus, wherein the compiler back-end reuse apparatus is configured to generate the target intermediate code and the target resource identifier of the preset format according to the intermediate code; and
a compiler back-end, wherein the compiler back-end is configured to generate the target machine code according to the target intermediate code and the target resource identifier.

10. The compiler back-end reuse method according to claim 2, wherein the compiler back-end reuse method further comprises:
acquiring a useless resource that is not used by the target intermediate code;
acquiring a useless set number of the useless resource, and mapping the useless set number to a preset set number; and
acquiring the useless resource according to the useless set number in the preset set number, and deleting the useless resource.

11. The compiler back-end reuse method according to claim 3, wherein the compiler back-end reuse method further comprises:
acquiring a useless resource that is not used by the target intermediate code;
acquiring a useless set number of the useless resource, and mapping the useless set number to a preset set number; and
acquiring the useless resource according to the useless set number in the preset set number, and deleting the useless resource.

12. The compiler back-end reuse method according to claim 4, wherein the compiler back-end reuse method further comprises:
acquiring a useless resource that is not used by the target intermediate code;
acquiring a useless set number of the useless resource, and mapping the useless set number to a preset set number; and
acquiring the useless resource according to the useless set number in the preset set number, and deleting the useless resource.

13. The compiler back-end reuse method according to claim 5, wherein the compiler back-end reuse method further comprises:
acquiring a useless resource that is not used by the target intermediate code;
acquiring a useless set number of the useless resource, and mapping the useless set number to a preset set number; and
acquiring the useless resource according to the useless set number in the preset set number, and deleting the useless resource.

14. The compiler back-end reuse apparatus according to claim 8, wherein the step of converting an original resource identifier corresponding to the intermediate code into a target resource identifier of the preset format comprises:
determining an original resource type identifier and an original binding number in the original resource identifier;
converting the original resource type identifier into a target resource type identifier of the preset format; and
converting the original binding number into a target binding number of the preset format.

15. The compiler back-end reuse apparatus according to claim 14, wherein the step of converting the original resource type identifier into a target resource type identifier of the preset format comprises:
acquiring a preset corresponding relationship, wherein the preset corresponding relationship comprises a corresponding relationship between a resource type identifier of the preset format and resource type identifiers of other formats; and
converting the original resource type identifier into the target resource type identifier according to the preset corresponding relationship.

16. The compiler back-end reuse apparatus according to claim 14, wherein a format of the original resource type identifier is SPIR-V format, and a format of the target resource type identifier is DXIL format.

17. The compiler back-end reuse apparatus according to claim 14, wherein the step of converting the original binding number into a target binding number of the preset format comprises:
forming the target binding number after sequentially numbering the same original binding numbers corresponding to different resources.

18. The compiler back-end reuse apparatus according to claim 8, wherein the compiler back-end reuse method further comprises:
acquiring a useless resource that is not used by the target intermediate code;
acquiring a useless set number of the useless resource, and mapping the useless set number to a preset set number; and
acquiring the useless resource according to the useless set number in the preset set number, and deleting the useless resource.

19. The compiler back-end reuse apparatus according to claim 18, wherein the compiler back-end reuse method further comprises:
acquiring a read instruction of reading the useless resource according to the useless set number in the preset set number, and deleting the read instruction; or
acquiring a write instruction of writing the useless resource according to the useless set number in the preset set number, and deleting the write instruction; or
acquiring the read instruction of reading the useless resource and the write instruction of writing the useless resource according to the useless set number in the preset set number, and deleting the read instruction and the write instruction.
